(19) United States
(12) Patent Application Publication
(10) Pub. No.: US 2003/0175389 A1
(43) Pub. Date: Sep. 18, 2003

(54) Method and system of devices for producing shaped and packed candy floss products

(76) Inventor: Valery Gennadievich Shaposhnikov, Russia (RU)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/311,427

(22) PCT Filed: Dec. 15, 2000
(86) PCT No.: PCT/RU00/00510

(30) Foreign Application Priority Data
Jul. 3, 2000 (RU) 2000117143

(51) Int. Cl. C12C 1/027

(52) U.S. Cl. 426/106

(57) ABSTRACT

The invetntion relates to a method for shaping candy floss products, producing a pellicle made of plastic film used for packing said products and for the manufacture packing units, in addition to devices for carrying out said method. The aim of the invention is to develop a method and sistem of devices for shaping candy floss-products having desired shape and dimensions, and to pack said products with the aid of the pellicle manufactured for this purpose. The method is carried out by the action of axial and circular forces upon a portion of candy floss in order to produce a product in the form of a ball by means of devices which comprise mould, hemispherical lids and shaping rings. The process of manufacturing the pellicles from thermoplastic film for packing the candy floss-products is carried out by heating and shaping the film with the aid shaping master moulds and die holes arranged on the devices which drive said tools by means of movable lids and locking hand levers. The packing of candy floss products wich the aid of the pellicle manufactured from thermoplastik film consists in placing the product between the pellicles, sealing the edges thereof, filling the pack with air in order to obtain an exctssive pressure and pressurize the pack. The device for pressurizing comprises a welding unit for sealing the edges of pellicles with the aid of a permanent heater and a needle air pipe for pressurizing. Afterwards, the needle air pipe is welded with the aid of a wire electrod. The invention makes it possibl to produce the shaped and packed candy floss products in keeping with consumer and sanitary standards.

### 1. Field of Application

The invention relates to a method for shaping candy floss products, producing a pellicle made of thermoplastic film for packing said products and for the manufacture packing units, in addition to devices for carrying out said method.

### 2. Background of the Invention.

The candy floss is manufactured in form of stretched sugar floss. Various devices to manufacture candy floss are known: rotating flat smooth metal disc or rotating drum with slits on the wall (USSR patent No 1807851, A23G3/00, published in 1993, USSR author's certificate No 266552, A23G3/10, published in 1970). Produced sugar floss is manually winded up on sticks and sold in this shape. It is clear that such product can only be consumed straight after the manufacture. It can not be stocked (due the flosses stick together) and transported and is not attractive enough for customers.

There are methods and devices for shaping packs made of thermoplastic materials (USSR author's certificate No 844485, B65B9/02, published in 1981) and methods of packing and devices for packing fragile articles (RF Patent No 2111908, B65B31/04, published in 1998) which have been accepted by the applicant as the closest analogues both in respect to method and system of devices for producing shaped and packed candy floss products.

The known method, which has been accepted as the closest analogue, does not ensure production of shaped candy floss products of a certain shape and size and packing them into the pellicles especially manufactured for that purpose.

### 3. Brief Summary of the Invention

### 3.1. The technical Aim of the Invention

The aim of the invention is to develop method and system of devices for producing shaped candy floss of a certain shape and size and packing into the pellicles especially manufactured for that. This enables easy production of shaped candy floss products, using simple and inexpensive equipment in conditions of small family business into coloured, convenient, attractive and reliable packing units conforming to required sanitary and other standards.

### 3.2. Essential Features of the Method

The assigned aim is achieved since the proposed method envisages product shaping operations and manufacturing of the pellicles made of thermoplastic film for packing products and packing said products afterwards.

Shaping of products is carried out by placing of a portion of candy floss into a semispherical mould and by action of axial and circular forces upon it in order to produce a product in form of a ball.

Manufacturing of the pellicles of thermoplastic film for packing candy floss products is carried out by shaping the pellicle with the aid of at least one semispherical shaping master mould with film heater and ring die. Before heating the film is placed on a table which has at least one positioning rim, then it is closed by a lid with ring die and elastic gasket and pressed leaving a gap between the lid and the shaping mould of 12-15 mm. The heating is carried out through this gap during 12-18 seconds, the pellicle is shaped by gradual bringing the film sheet in contact with the shaping mould. At first the central part of the film sheet is brought in contact at a speed of 20-30 mm/sec, this part of the film is kept in this position for 1-1.5 sec and, afterwards, the rest of the film sheet is brought in contact with the shaping mould at the same speed. After such gradual shaping the film sheet is allowed to cool with the aid of fan for 6-8 seconds and produced pellicle is removed from the shaping mould and the table.

Candy floss products packing is carried out by placing the product between two semispherical pellicles made of thermoplastic film, pressing the edges thereof between ring table with elastic gasket and permanent heater, welding the pellicles with the help of a heater producing the pack with a channel in form of a nipple for air intake to obtain excessive pressure and sealing the pack.

Air intake and pressurization are carried out with the aid of a needle air pipe with exact positioning through the channel in the pack, the sealing of the pack is carried out by sealing of said channel without withdrawal of the needle air pipe. The pellicle edges are welded independently and simultaneously with air supply to the pack and its sealing.

To implement said method the system of devices that ensures shaping operations, the manufacture of pellicles of thermoplastic film and the packing has been proposed.

The device for shaping products in the system of devices for producing shaped and packed candy floss products (variant 1) comprises bed plate with semispherical mould and shaping lid of the same shape with vertical lever to enable axial and circular action upon candy floss.

The device for shaping the product in the system of devices for producing shaped and packed candy floss (variant 2) comprises bed plate with semispherical mould with loading funnel with shaping ring at the bottom and vibration motor installed to the bed plate and linked to the mould with the help of eccentric.

The device to manufacture pellicles of thermoplastic film for packing products in the system of devices for producing shaped and packed candy floss products (variant 1) consists of bed plate, table fixed to it by posts with two positioning rims, two semispherical moulds aligned with positioning rims under them and fixed so that they can be moved vertically with the aid of sleeves installed to guide posts, sleeves are hinged axially with lever-carriages equipped with rollers and levers rotating in vertical plane. The lids with fixed fans and locking hand levers with clasps are hinged to the table in the area of the rims. The lids have ring recesses with dies to which elastic gaskets are fixed, brackets with pins for clasps of the lids locking hand levers and base sleeve which is located between positioning rims. A post with hand lever, which can be turned around vertical axis, is installed to the sleeve, a heater is fixed to the post with the help of a traverse. The moulds are rigidly fixed to the sleeves, the guide posts for sleeves to enable vertical movement are firmly fixed to the bed plate.

The device to produce the pellicles of thermoplastic film for packing products in the system of devices for producing shaped and packed candy floss products (variant 2) consists of a bed plate, a semispherical shaping mould firmly fixed to it and a ring table spring-loaded on posts above it with positioning rims and diametrical slots, a clasp pin is in one of the slots and a bracket with a fan hinged to the other. The bracket with the fan is linked with the help of a shackle to the bed plate. The lid is made with a ring recess with a die and a hand lever with a locking clasp, a heater is hinged in the slot of one of the posts.

The device for packing products in the system of devices for producing shaped and packed candy floss products consists of a bed plate with a welding unit for welding the edges of the pellicles made of thermoplastic film, a device for sealing the pack and filling it with air to obtain excessive pressure including a needle air pipe. The pellicles edges welding unit includes a ring table with an elastic gasket and two diametrical brackets, to one of which a spring loaded traverse is hinged, it carries heater with a hand lever with a slot to interact with a pin of the other bracket, an electromagnet is cinematically linked with the traverse hand lever when it is closed. The device for air supply into the pack and pack sealing consists of a ring table with a wire electrode, a control unit to supply air through a needle air pipe and a sealing process control unit which consists of a frame with an electrode activating button and a clamp spring-loaded to the lever and equipped with an elastic element to press the pack to the electrode, the needle air pipe, a clamp and a handle are hinged on one axis to the frame, a bell-crank is hinged to the frame to ensure cinematic link of the handle and the electrode activating button.

### BRIEF DESCRIPTION OF THE DRAWINGS

The claimed invention is illustrated by the drawings:

FIG. 1 shows device for shaping candy floss products in the beginning of shaping process (1^{st} variant);

FIG. 2 shows the same but in the end of shaping process;

FIG. 3 shows device for shaping candy floss products (2d variant);

FIG. 4 shows device to produce the pellicles for packing candy floss products (1^{st} variant);

FIG. 5 shows the pellicle;

FIG. 6 shows device to produce the pellicles for packing candy floss products (2d variant);

FIG. 7 shows device for packing candy floss products (device for welding the pellicles edges in operational condition, device to supply air into the pack and to seal the pack—ready for operation);

FIG. 8 shows device for air supply into pack and sealing, ready for operation, side view;

FIG. 9 shows the same when air is supplied;

FIG. 10 shows heater, bottom view;

FIG. 11 shows heater, general view;

FIG. 12 shows finished pack;

In the drawings

1 detail—a bed plate of device for shaping candy floss products (variant 1), detail 2—a post, detail 3—a semispherical mould, detail 4—a shaping lid, detail 5 a hand lever;

detail 6—a bed plate of the device for shaping candy floss products (variant 2), detail 7—a vibration motor, detail 8—a traverse, detail 9—a post, detail 10—a semispherical mould, detail 11—a post, detail 12—a loading funnel, detail 13—a shaping ring.

detail 14—a bed plate of the device to produce the pellicle of thermoplastic film (variant 1), detail 15—a guide post, detail 16—a sleeve, detail 17—a semispherical shaping mould, detail 18—a pin, detail 19—a carriage, detail 20—the rollers, detail 21—a hand lever, detail 22—a post, detail 23—a 2 place table, detail 24—a positioning rim, detail 25—a bracket, detail 26—a pin, detail 27—a flange, detail 28—a lid, detail 29—a post, detail 30—a fan, detail 31—a bracket, detail 32—a pin, detail 33—a locking hand lever, detail 34—a clasp, detail 35—a ring die, detail 36—an elastic gasket, detail 37—a bracket, detail 38—a locking pin, detail 39—a base sleeve, detail 40—a post, detail 41—a hand lever, detail 42—a traverse, detail 43—a heater, detail 44—a control mirror,

detail 45—a bed plate of device to produce the pellicles of thermoplastic film (variant 2), detail 46—a post, detail 47—a semispherical shaping mould, details 48, 49—the guiding posts, detail 50—a slot, detail 51—a table, detail 52—a positioning rim, detail 53—a sleeve, detail 54—a lever, detail 55—a slot; detail 56—a clasp pin, detail 57—a bracket pin, detail 58—a hinge post, detail 59—a bracket, detail 60—a fan, detail 61—a shackle, detail 62—a bracket , detail 63—a lid, detail 64—a ring die, detail 65—a pin, detail 66—a lever, detail 67—a clasp, detail 68—a pin, detail 69—a bar, detail 70—a heater, detail 71—a lever, detail 72—a spring, detail 73—a limit switch, detail 74—the “L” shape slots, detail 75—a control mirror,

detail 76—a bed plate of candy floss products packing device, detail 77—a sleeve, detail 79—an electromagnet, detail 80—a table, detail 81—an elastic gasket, detail 82—a bracket, detail 83—a pin, detail 84—a bracket, detail 85—a spring, detail 86—a pin, detail 87—a pull rod, detail 88—a shackle, detail 89—a pin, detail 90—a traverse, detail 91—a pin, detail 92—a hinge post, detail 93—a spring, detail 94—the spring ends, detail 95—the hinge rollers, detail 96—a pin, detail 97—a locking lever, detail 98—a lever slot, detail 99—a nut, detail 100—a spring ring, detail 101—a heater, detail 102—a ring holder, detail 103—a temperature sensor, detail 104—a shaping bead for welding pellicle edges, detail 105—a shaping bead for welding air channel joint, detail 106—a ring housing, detail 107—an inductor housing, detail 108—a heater, detail 109—the leads, detail 110—an insulator, detail 111—a lead cover, detail 112—a bolt, detail 114—a shaft, detail 115—a shaft end, detail 116—a light channel, detail 117—a photodiode, detail 118—LED, detail 119—a ring table, detail 120—a block, detail 121—an air control unit housing, detail 122—a sealing process control unit housing, detail 123—an electrode, detail 124—a stop button, detail 125—a light channel, detail 126—a photo pair, detail 127—a pin, detail 128—a lever, detail 129—a lever arm, detail 130—a sliding button, detail 131—a light channel, detail 132—a photo pair (photodiode and LED), detail 133—a lever arm, detail 134—a fork lever shoulder, detail 135—a fork lever, detail 136—a pin, detail 137—a needle air pipe, detail 138—a pressing fork, detail 139—an elastic element, detail 140—a guide, detail 141—a guide spring, detail 142—an air pipe hose, detail 143—a welded joint of the pellicle edges, detail 144—a joint of air supply of channel walls, detail 145—a sealing joint, detail 146—an air supply channel.

### 4. Description of Method, System of Devices and Industrial Application

Candy floss products shaping method is carried out as follows: a portion of candy floss is positioned on a relevant sheet of film in a semispherical mould and, afterwards, under the action of axial and circular forces a product in form of a ball is shaped.

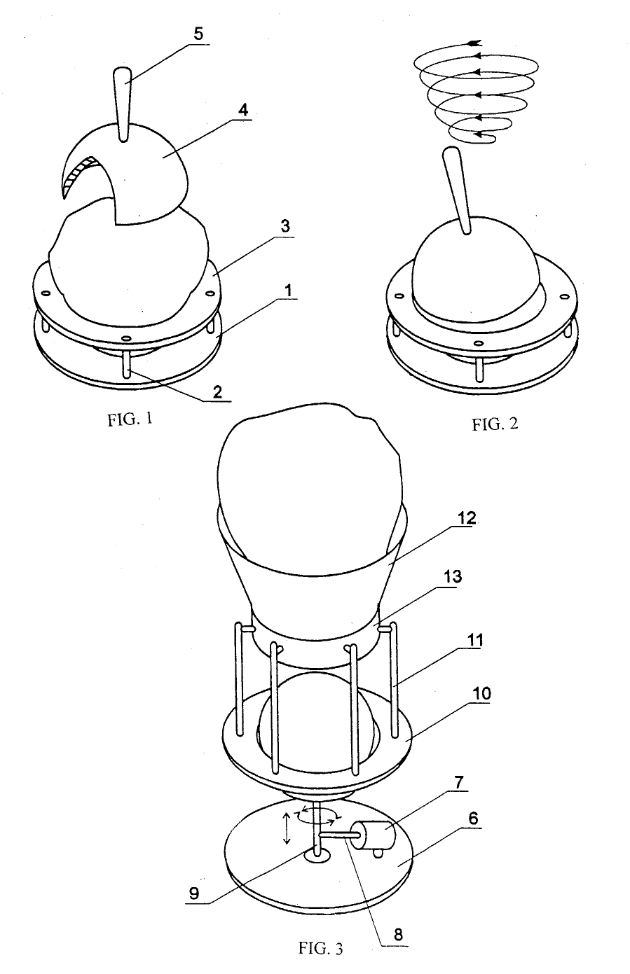

Device for shaping candy floss products (variant 1) consists (FIGS. 1 and 2) of a stationary bed plate 1 to which a semispherical mould 3 is firmly fixed on posts 2 and a shaping lid 4 of the same shape with a lever 5.

The device is working the following way:

A portion of candy floss is placed on the semispherical mould 3 (FIG. 1), which with the help of spiral motion (FIG. 2) is shaped into a ball of the size of the mould. Candy floss shaped product is removed from the mould 3 ready for packing into thermoplastic film pack.

In the other variant (variant 2) the device for shaping candy floss products consists of the stationary base 6 with the vibration motor 7 rigidly fixed to it, which is cinematically connected with the post 9 with the help of the eccentric by the traverse 8, a spindle 9 is installed to the bed plate 6 and has a rigidly fixed semispherical mould 10 with the loading funnel 12 with the shaping ring 13 is fixed on the posts 11.

The device is working the following way:

A portion of candy floss is loaded into the loading funnel 12 and due to vibration is supplied to the semispherical mould 10. In the mould by the action of rotary-oscillating motion from the sleeve 9 through eccentric from the traverse 8 of the vibration motor 7 the product is shaped into a spherical product ready in size and shape for packing into the pellicle of thermoplastic film.

Producing the pellicle of thermoplastic film for packing candy floss products is carried out the following way:

The thermoplastic film sheet is positioned on the table with at least one positioning rim. Before heating the film sheet is closed by the lid with the ring die and the elastic gasket and is pressed leaving a 12-15 mm gap between the lid and the semispherical shaping mould, heating is carried out through said gap during 12-18 sec. The pellicle shaping is carried out gradually bringing the film sheet in contact with the shaping mould: first, the central part of the film is brought in contact at a speed of 20-30 mm/sec, it is kept so for 1-1.5 sec and, afterwards, the rest of the film at the same speed is brought into contact with the shaping mould. Afterwards, the film is cooled by the fan for 6-8 sec. Produced pellicle is removed from the shaping mould and the table.

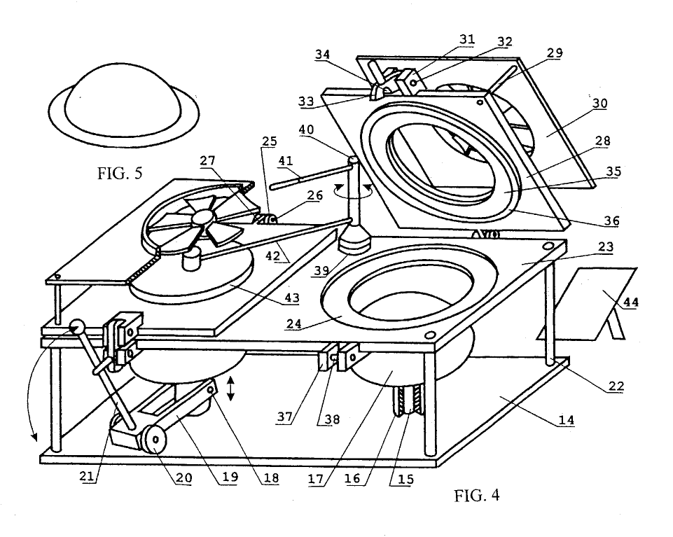

The device (variant 1, FIG. 4) is proposed to produce the pellicle of thermoplastic film for packing candy floss products. It consists of the bed plate 14 to which the guide posts 15 are fixed. The semispherical shaping moulds 17 are fixed to the sleeves 16 which reciprocate on the guide posts. The sleeves 16 with by the pins 18 are hinged to the carriage levers 19 with the rollers 20 and the lever 21. The 2 place table 23 with the positioning rims 24 is fixed by the posts 22 to the bed plate 12. The lids 28 are hinged to the table 23 by the bracket 25 and by the pin 26 and the hinge shoulder 27. The fans 30 and the brackets 31 with the hinged locking hand levers 33 with the clasps 34 by means of the pin 32 are fixed to the lids. The shaping ring dies 35 are fixed to the lids 28 with the elastic gaskets 36. The brackets 37 with the locking pins 38 and the base sleeves 39 with rotating sleeve 40 with the lever 41 and the traverse 42 with the heater 43 are fixed to the table 23. The control mirror 44 is positioned near device.

Device is working the following way:

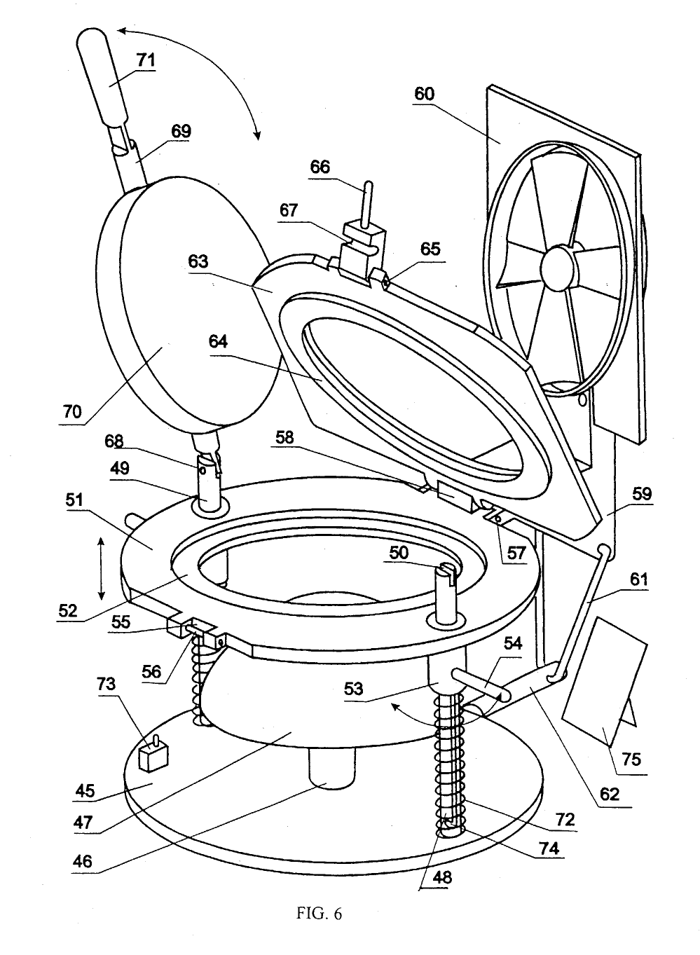

The heater 43 is removed from the table by rotation of the lever 41 on the sleeve 40 and is heated to an operational mode during 20-25 min. The lid 28 is hinged out and a thermoplastic film sheet is positioned to the positioning rim 24, the lids 28 are closed by the locking clasps 34 of the locking levers 33 clasping to the locking pins of the brackets 37. The heater 43 by rotating the lever 41 is placed over the 1^{st} film sheet pressed at a distance of 13 mm and kept so for 12-18 seconds until the film is heated to a temperature close to the film melting temperature which is required for shaping of the thermoplastic film. The film is controlled with the help of the mirror 44. Afterwards, the heater 43 by the lever 41 is moved to the next film sheet. On the 1^{st} film sheet by moving the lever 21 down the carriage 19 is lifted up with the shaping mould 17 to graphical part of the film at a speed of 20-30 mm/sec keeping it for 1-1.5 mm to avoid distortion of graphics. After that shaping is completing at initial speed, the fan 30 is switched on by end switch to cool the film. The fan is cooling mostly edge of the ring die preventing its sticking to the film. After 6-8 sec. of cooling the shaping mould 17 is returned to its initial position by lifting the lever 21 up, the lid 28 is lifted up and produced pellicle is removed from the positioning rim 24 (FIG. 5). Afterwards, the cycle is repeated again and it is carried out simultaneously on the 2 positioning rims, combining time required for heating the film on one positioning rim with time required for shaping, keeping, cooling, removal of produced film and positioning the new sheet on the other rim.

The other variant of device for producing pellicles of the thermoplastic film for packing candy floss products (variant 2) consists of the bed plate 45 to which the semispherical shaping mould 47 is fixed on the post 46, the vertical guide posts 48 and 49 with the slots 50 to which the table 51 installed with the positioning rims 52 for positioning the thermoplastic film. The table 51 is made with the rotating sleeves 53 with the hand levers 54 to enable its vertical reciprocation motion by the guide posts 48 and 49. The table 51 has the diametrical slots 55 in one of which sits the clasp pin 56 to the other post 58 is fixed and the bracket 59 with the fan 60 is hinged. The bracket 59 is hinged by means of the shackle 61 to the bed plate 45 by the bracket 62 firmly fixed to it. The lid 63 is fixed to the hinge bracket 58 through one of diametrical slots and pin, the ring die 64 is in the hole of the lid. In the other slot the hand lever 66 with the locking clasp 67 is hinged by the pin 65 for cinematic interaction with the clasp pin. The bar 69 with the heater 70 and the lever 71 is fixed in the slot 50 of the post 49 by the pin 68. The table 51 by the sleeves 53 is supported vertically by the springs 72. The end switch is installed to the bad plate 45 for cinematic interaction with bottom plane of the table 51 and for turning the fan 73 on. The posts 48 and 49 are made with the “L” shape slots 74 for interaction with the levers 54 inside of the sleeves 53. The control mirror 75 is located near the device.

The device is working the following way:

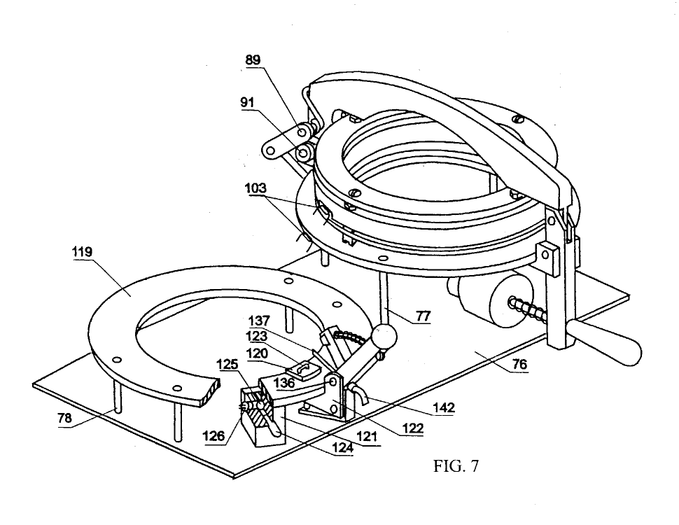

A film sheet (FIG. 6) is positioned on the positioning rim 52 of the table 51 on initial stage. Then the lid 63 is lowered and the film is pressed, the lever 66 with the clasp 67 fixes the lid to the pin 56 in the slot 55. The heater 70 is lowered by the lever 71 and fixed in the slot 50 of the post 48.

During 12-18 sec. the film sheet is heated under visual control by means of the mirror 75, afterwards, the heater 70 is returned to initial position.

Using the levers 54 the table 51 is lowered to bottom position and fixed by ends of the lever 54 which are positioned inside sleeves 53 in the “L” shape slots 74 of the posts 48 and 49 by turning the levers 54 90° to inside. Almost melted film takes shape of the shaping mould 47. When the table 51 is lowered, the shackle 61, which is hinged at the bottom to the post 62, turns bracket 59 with the fan 60 parallel to the table 51. The bottom plane of the table interacts with the micro switch 73 and turns on the fan 60, which cools the ring die 64 for 6-8 sec. and the pellicle being shaped. After that the levers 54 are displaced and the springs 72 return the table 51 to initial position. The lid 63 is opened and the shaped pellicle is removed from the table 51.

Packing the candy floss products in thermoplastic pellicle is carried out in the following succession:

A film is positioned on the ring table, the candy floss product is placed on it and closed by the second pellicle. During 8-10 sec. the heater is lowered and air supply channel edge joints are formed. Afterwards, the heater is returned by the electric magnet to initial position. The welded pack is placed on the air supply and final sealing device and the pack is placed on the needle air pipe through air supply channel. Afterwards, it is positioned on the ring table and air is supplied into the pack to obtain excessive pressure of 0.1-0.15 kg/cm2. Afterwards, not withdrawing the needle air pipe the pack is pressed to the electrode by the elastic element. During 1.2-1.5 sec. a joint is made on the pack, air supply channel is welded and the pack is sealed. The joint is kept for 2-3 sec and finished product in thermoplastic pack is removed from the device. During the whole technological cycle, simultaneously with sealing pellicles on device for pellicle edges welding, the pack is filled with air by device for air filling and full sealing of the pack to obtain excessive pressure and for full sealing of the product.

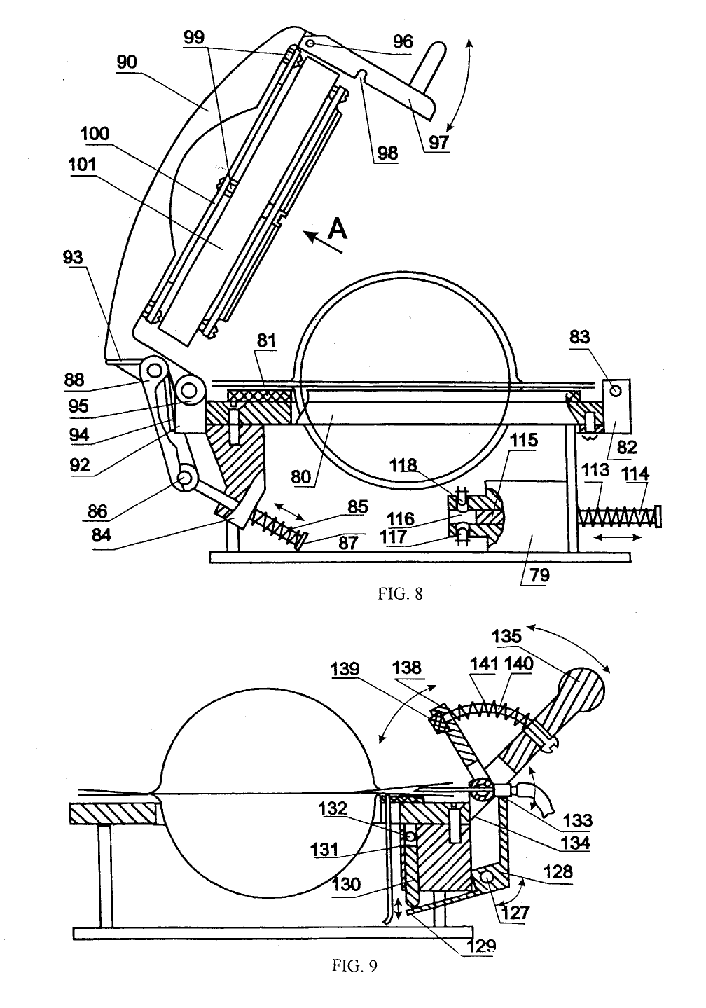

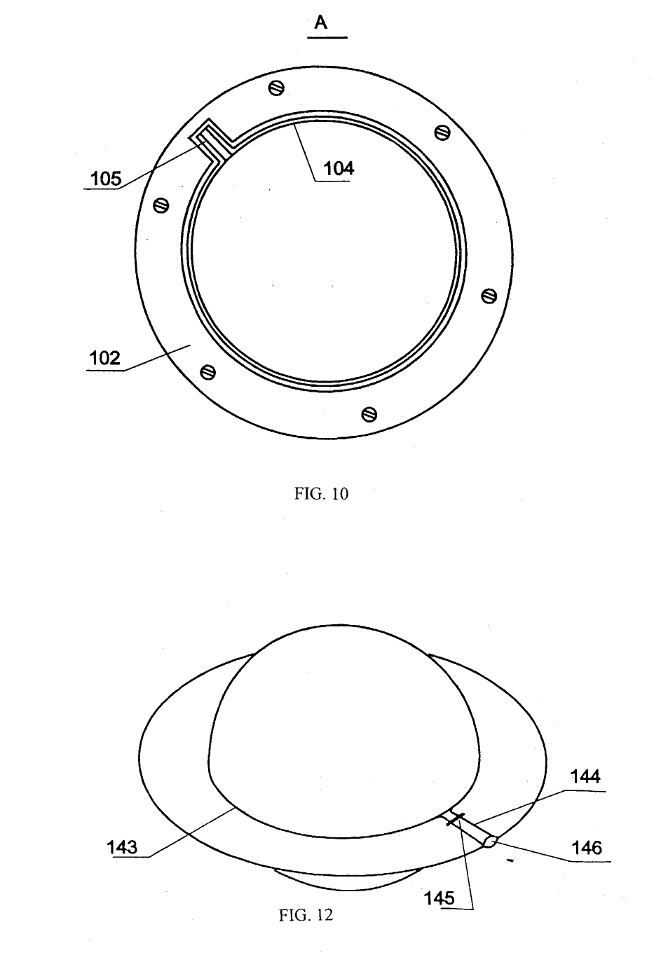

To pack candy floss products a device (FIG. 7, 8, 9, 10, 11, 12) which consists of the bed plate 76 on which pellicles edge welding device is fixed by the posts 77. Air filling device for filling the pack with air to obtain excessive pressure and its full sealing on the posts 78 fixed to the bed plate. Pellicle edges welding device (FIG. 8) consists of the electromagnet 79 fixed to the bed plate and the table 80 on which the elastic gasket 81, the front bracket 82 with the clasp pin 83 and the back bracket 84 are fixed. The back bracket is cinematically by the spring 85 linked on one side and fixed by the pin 86 on the other side by the pull rod 87 is linked by means of the shackle 88 and the pin 89 (FIG. 7) to the traverse 90. The traverse 90 by means of the pin 91 (FIG. 7) is linked to the hinge bracket shoulder 92 of the bracket 84 and cinematically through shaped damper spring 93 and its ends 94 linked to the posts 92 of the bracket 84 and cinematically linked to the rollers 95 on the pin 91 by side surface of the shackles 88, one end of which is hinged to the pin 86, the other end is linked to the pin 89. The second end of the traverse 90 is hinged to the locking hand lever 97 which has the slot 98 to clasp to the pin 83 of the front bracket 82. The traverse 90 by the nut 99 and the ring spring 100 is linked cinematically by “Cardan jointing” principle to the heater 101 with the immobile ring holder 102 (FIG. 10). The temperature sensors 103 are fixed to the heater 101 and the table 80. The heater 101 has continuous shaping beads to weld pellicles edges 104 and joint of air channel 105 (FIG. 10) on the frame 106 (FIG. 11). Ring inductor is enclosed in the housing 107 comprising external groove with dielectric coating into which a smooth wire Ni—Cr alloy heater 108 laid with the leads 109 enclosed in the insulators 110. The ring lid 111 of the heater 101 is fixed by the screws 112. The electromagnet 79 has the shaft 114 with the spring 113. One end of it is in the light channel 116. Photodiode 117 and LED 118 are fixed on one axis perpendicularly.

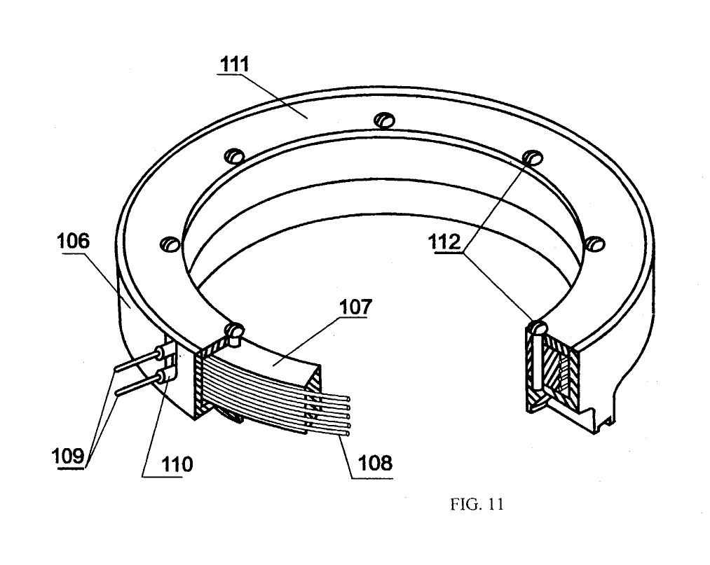

Device for filling with air and full sealing of the pack (FIG. 9) consists of the ring table 119 (FIG. 7) with the block 120 fixed to it, the air supply control housing 121 and the sealing control unit housing 122. The wire electrode 123 is fixed to the block 120. The light flow interrupting button 124 is on the block 121. On the opposite ends in the light channel 125 a photo pair (LED and photodiode) is located perpendicularly to the button channel 124. On the frame 122 on the pin 127 (FIG. 9) the hinged bell-crank 128 is linked cinematically by one end with the sliding button 130 which is in the light channel 131 enabling reciprocating motion. The photo pair 132 (LED and photodiode) is installed perpendicularly to the channel. The other arm 133 of the lever 128 is linked cinematically with the shoulder 134 of the fork lever 135 which with the help of the pin 135 (FIG. 7) is hinged to the frame 122. The needle air pipe 137 (FIG. 7) is linked with the air hose 142. Pack (FIG. 12) with the welded joint 143, wall joint of the air supply channel 144, the sealing joint 145 and the air supply channel 146 in form of a nipple.

Device is working as follows:

The traverse 90 of the pellicle edges welding device (FIG. 8) is lifted up. The heater 101 is on for 15-20 min. to reach working temperature specified by the temperature sensitive resistor 103 (FIG. 7). Device to fill the pack with air and for final sealing has lifted the fork handle 135 and the needle air pipe 137 (FIG. 7).

Thermal resistant adhesive film is adhered to the holder ring 22, the shaping beads 104 and 105 of the heater 101 (FIG. 11). Shaped pellicle made of thermoplastic film is positioned on the ring shape table 80 (FIG. 8). Candy floss product is placed on the pellicle and closed by the second pellicle. The heater 101 by the hand lever 97 is lowered to bottom position (FIG. 7) and fixed to the bracket pin 83 of the bracket 82. In this position the pressing of pellicles by the shaping beads 104 and 105 shape pack joint for a period of time set by signal of the photodiode 118 and LED 119. The signal occurs when light flow is closed by movement of the end 115 of the shaft 114 of the electromagnet 101 by action of the locking hand lever 97. Compression force from the heater 101 to the elastic gasket 81 and pack is specified by the spring ring 100 and height of the nut 99. Uniformity of compression is achieved due to “Cardan jointing” of the heater 101 to the traverse 90 and cross positioning of the nuts 99. After completion of joint forming during 5-12 sec. (depending on thickness and physical properties of material of thermoplastic film ) the electronic control unit sends signal to the electromagnet 79 and the shaft 114 pushes end of the hand locking lever 97. The heater 101 by means of the spring 85, through the tie 87 and the shackle 88 is moved to initial position. The traverse 90 by the ends 94 of the damper spring 93 is supported by the vertical post 92 of the bracket 84 smoothly stops in initial position. In the process of welding of the pellicle edges the temperature in the area of joint is kept within accuracy limits of 0.7% by integrated signal the from temperature sensors 103, one sensor is on the heater 101 the other is on the ring table 80 (FIG. 7). Uniformity of temperature pattern of the heater is kept within 0.3% due to the inductor is combined with the casing 107 and the smooth wire heater 108 is positioned on it. Afterwards, the pack welded along joint 143 and 144 (FIG. 11) is directed to the device for supply of air and sealing where it is connected to the needle air pipe 137 by the air supply channel 146 and laid to the ring table 119 (FIG. 9). A new film is positioned on device for welding the pellicles and cycle is repeated.

By signal from the photo pair 126 (FIG. 7) by pressing the button 124 a compressor is turned on and the pack is pressurized to obtain excessive pressure of 0.1-0.15 kg/cm2, afterwards, not withdrawing the needle air pipe 137, moving the lever 135 (to the pack) the pack is pressed onto the electrode 116 (FIG. 7) by the elastic element 139 of the pressing fork 138. At the same time from signal received after the button 130 stops light flow of the photo pair 132 due to movement of the lever 128 around axis 127 and pressure from the shoulder 134 of the handle-fork 135 voltage is supplied to the electrode 123 and during 0.5-¼ sec. (depending on physical properties of thermoplastic film) by signal from the electronic control unit a joint 145 is formed on the pack (FIG. 12) sealing the pack. Joint is kept for 2-3 sec. the fork-handle 135 is returned to initial position and ready candy floss product is removed from the device.

As a result of application of proposed method and system of devices for producing shaped and packed candy floss products due to slow, layer-by-layer cooling the pellicle by shaping mould a high level of quality is achieved due to the uniform thickness of the pellicle and that is a very important condition that ensures no air bubbles when excessive pressure is obtained in the pack. Besides, due to specification of shaping mode dynamics (time, speed, temperature, pausing) change of graphic pictures on the pack is kept within suitable limits

The use of proposed method and system of devices for packing of candy floss products results in a considerable improvement of welded joint quality and sealing due to:

change of joint due to introduction of air supply channel, thus removing problem of exact positioning of the needle air pipe and its withdrawal when welding;

improvement of uniformity of the heater pressure to the pack due to “Cardan jointing” principle;

uniformity of temperature pattern of the joint due to special design of the heater;

maintaining exact temperature when welding the joint due to reliable, by thermal contact, positioning of the integrated temperature sensors.

Automatic removal of the heater by the electromagnet, positioning of the air supply control unit on device, jointing up turn on operation of air supply channel welding electrode and pack pressing to the electrode in the sealing process control unit improves working conditions for operator.

Simultaneous performance by one operator of technological cycles of welding edges of the pellicles on one device with air filling and sealing on the other will increase twice the labour productivity.

The described devices are designed for the use in small-scale production, small business because they are small, simple and reliable and do not require highly skilled personnel.

Candy floss products produced and packed this way can be stocked for a long time and transported to a long distance. Also they acquire functions of funny, bright, attractive and edible toy.

What is claimed is:

1. A method for producing shaped and packed candy floss products, which includes product packing, characterized in that
involvement of shaping of the product and manufacture pellicles of thermoplastic film for packing products;
shaping of the product is carried out by placing a portion of candy floss on a semispherical mould by action of mechanical axial and circular forces upon the portion of candy floss with producing the product in form of a ball,
a production of the pellicles of the thermoplastic film is carried out by shaping the pellicle with at least one semispherical shaping mould and a ring die and heating the film sheet;
the product is packed by placement between two semispherical pellicles of the thermoplastic film and pressing edges of the pellicles between a ring table with an elastic gasket and permanent heater and the edges welding to produce the pack with a channel in form of a nipple to supply air with excessive pressure with the help of a needle air pipe without withdrawing the from the needle air pipe channel when the channel is sealed.

2. The method of claim 1, characterized in that
when the pellicles of thermoplastic film are produced the film sheet is located on the table with at least one positioning rim before heating, then covered by a lid with a ring die and an elastic gasket and pressed leaving a gap between the lid and the shaping mould of 12-15 mm;
heating is carried out through the said gap during 12-18 sec. and the pellicle is shaped by gradual bringing in contact of film sheet with the shaping mould,
first a central part of the film is brought in contact at a speed of 20-30 mm/sec., kept so for 1-1.5 sec. and, then a rest part of the film is brought in contact with the shaping mould;
afterwards, the film is cooled with the aid of a fan for 6-8 sec. and finished pellicle is removed from shaping mould and table.

3. The method of claim 1, characterized in that
air supply and obtaining excessive pressure being carried out by means of the needle air pipe through channel in the pack, sealing the pack is carried out by sealing of said channel, edges welding is done independently and simultaneously with air supply to the pack and sealing the pack.

4. A device for shaping products in the system of devices for producing shaped and packed candy floss products (first embodiment) characterized in that the device comprising a bed plate, a semispherical tank installed on the bed plate and a semispherical shaping lid with a hand lever enabling an action of axial and circular forces upon candy floss.

5. The device of claim 4, characterized in that the hand lever is on a vertical axis of the semispherical shaping lid.

6. A device to shape products in the system of devices for producing shaped and packed candy floss products (second embodiment) characterized in that the device comprising: a bed, a semispherical mould installed on the bed plate, a loading funnel with a shaping ring and a vibration motor installed on the bed and linked with the mould by means of an eccentric.

7. A device to produce pellicles of a thermoplastic film to pack products in a system of devices for producing candy floss shaped and packed products (variant 1) characterized in that the device comprising: a bed plate, a ring table with two positioning rims fixed to the bed plate by means of a post, two semispherical shaping moulds aligned with the positioning rims under them and fixed by means of sleeves enable vertical movement, said sleeves installed to guides, the sleeves are linked with carriage levers with rollers and the levers which can be turned in a vertical plane, the lids with fans and locking levers with clasps are hinged to the table in an area of the rims, the lids have ring holes with ring dies to which elastic gaskets are fixed, brackets with the shafts are fixed to the table for interaction with lids locking lever clasps and supporting sleeve with a post with an additional lever, said post can be turned around vertical axis located between positioning rims, and a heater is fixed to the post with aid of traverse.

8. The device of claim 7, characterized in that the shaping moulds which are rigidly linked to the sleeves and the guide posts are fixed to the bed plate.

9. A device to produce pellicles of thermoplastic film to pack products in a system of devices for producing shaped and packed candy floss products (variant 2) characterized in that the device comprising:
a bed plate, a semispherical shaping mould firmly fixed to it and a ring table on spring posts with possibility to move on them and to get fixed with positioning rim and diametrical slots in one of which axle-hook is located, a bracket with a fan is hinged in an other slot and linked through shackle to the bed plate and a lid, the lid is made with a ring hole with a ring die and a hand lever with a locking clasp to interact with a bed plate clasp pin, and a heater is hinged to the slot of one of the posts.

10. A device to pack products in a system of devices for producing shaped and packed candy floss products that includes a bed plate, a immovable ring table with an elastic ring gasket, a needle air pipe, a wire electrode and an elastic element to press the pack to the electrode is characterized by the fact that device for welding pellicles edges is installed to the bed plate with the product positioned between pellicles, and a device for sealing the pack and supply of air into it to obtain excessive pressure includs a needle air pipe,
the device for welding the pellicles edges comprising the ring table with the elastic gasket and two diametrically positioned brackets, on one of the braskets the spring traverse is fixed with a heater fixed to the traverse by “Cardan jointing” principle, the heater is hinged for the purpose of welding the pellicles edges,
and channel in form of a nipple to supply air,
the traverse is made with a lever with slot to interact with a clasp pin located on the other bracket,
and an electromagnet cinematically linked with the traverse lever when it is closed, the device to supply air to the pack and to seal the pack comprising the ring table, the wire electrode being fixed to the table which ensures sealing the channel for air supply;
a control unit of air supply through the needle air pipe and a sealing process control unit comprising housing with an electrode activating button, a press with the spring lever and with elastic element to press the pack to the electrode, wherein the needle air pipe, the press and the lever are hinged to the electrode on one axis, a bell-crank is hinged to the housing to ensure cinematic link of the lever and the electrode activating button.
